(19) United States
(12) Patent Application Publication
(10) Pub. No.: US 2014/0241216 A1
(43) Pub. Date: Aug. 28, 2014

(54) PORTABLE DEVICE WITH DYNAMIC RANKING MODULE

(71) Applicants: Yi-Chuan CHENG, Yongjing Township (TW); Kuo-Ching CHIANG, New Taipei City (TW)

(72) Inventors: Yi-Chuan CHENG, Yongjing Township (TW); Kuo-Ching CHIANG, New Taipei City (TW)

(21) Appl. No.: 13/778,557

(22) Filed: Feb. 27, 2013

(51) Int. Cl. H04M 3/436

(52) U.S. Cl. CPC H04M 3/436
USPC 370/271

(57) ABSTRACT

A portable communication, comprises a control unit, a display coupled to the control unit; a contact book coupled to the control unit to store a list of contact person's phone number, e-mail address, account information, or the combination; a ranking module being responsive to a usage frequency of the list of contact person to re-arrange the list of contact person to allow high ranking contact person is listed on a top or a first page of an interface displayed on the display; a phone filter including an interface on a display to allow a user to input a black list of person and corresponding phone number to filter out a phone which is listed in the black list.

### FIELD OF INVENTION

The present invention relates to a portable communication device, particularly to a portable device having dynamic ranking module

### BACKGROUND OF INVENTION

Because of the development of the information technology (IT), the information could be exchanged with higher capacity and faster speed. Internet is designed as an open structure to exchange information freely without restriction. The third generation mobile phone standard allows the user to access video communication through the air. Thus, certain communication service requiring real time information exchange, such as viewing a live video, has become feasible through mobile phone communication network or Internet. Portable computers and personal computer or smart phone have been widely used for each area. Laptop (notebook) and tablet style computers may be found in the work environment, at home or used during travel, perhaps as a result of their advantages, particularly when equipped with wireless communicating technology. Advantages such as low power consumption, small size, low weight make the portable computer available to nearly everyone everywhere. Smart TV is a new product for nowadays as well.

### SUMMARY OF THE INVENTION

The present invention provides a system for synchronous communication via internet comprising a local area network and a terminal is coupled to the internet; a portable device with dual network linking capability module is used to transmit information through a RF module via the cellular network or the wireless local area network (WLAN) module via the Internet, wherein the portable device includes an internet phone module and the WLAN module to allow an user may synchronously transmit or receive data through the internet, portably, wherein the transmitted information is selected from audio signal, video signal and the combination thereof. The terminal can be a computer, a personal digital assistant (PDA), a notebook, cellular or a smart phone, which is able to access the internet network via the local area network. The system further comprises a mobile phone communication service network. The system further comprises an exchanging service mechanism bridging the internet and the mobile phone network to facilitate the communication there between. The system may further comprise a public switch telephone network (PSTN).

TV with multi-display window includes a control unit, a display coupled to the control unit; a display dividing module coupled to the control unit to divide the display into multiple display windows; a local area network module coupled to the control unit; a communication module coupled to the control unit, wherein the communication module includes an instant chat module or network phone module; wherein a TV program, and an interface of the communication module are assigned into the multiple display windows to allow a user conduct a call or chat with a remote terminal while watching TV program.

The TV further includes a wireless video communication module includes W-CDMA [symbol] CDMA2000 [symbol] CDMA2001 [symbol] TD-CDMA [symbol] TD-SCDMA [symbol] UWC-136 [symbol] DECT or 4G module. The local area network module includes Wi-Fi module, WiMAX (Worldwide Interoperability for Microwave Access) module. The TV include a multi-tasking module coupled to the control unit for reassigning the control unit between at least one task and another task to achieve parallelism. The TV Skype VoIP phone module is coupled to the control unit to transmit or receive data through the local area network module.

The TV further includes a user motion control module coupled to the control unit. The multiple display windows include at least one main window and at least one sub-window, wherein the TV program is assigned into the main window and the interface is assigned into the sub-window. The TV program is re-assigned into the sub window and the interface is re-assigned into the main-window. Alternatively, the TV program is assigned into the sub window and the interface is assigned into the main-window; the TV program is re-assigned into the main window and the interface is re-assigned into the sub-window.

A portable communication, comprises a control unit, a display coupled to the control unit; a contact book coupled to the control unit to store a list of contact person's phone number, e-mail address, account information, or the combination; a ranking module being responsive to a usage frequency of the list of contact person to re-arrange the list of contact person to allow high ranking contact person is listed on a top or a first page of an interface displayed on the display; a phone filter including an interface on a display to allow a user to input a black list of person and corresponding phone number to filter out a phone which is listed in the black list. A signal of the incoming phone is received, the phone filter checks whether or not the incoming phone number is listed on the black list; if the incoming phone is already listed in the black list, the phone filter hands off the phone automatically. A multi-tasking module is coupled to the control unit for reassigning the control unit between at least one task and another task to achieve parallelism. A network phone module including a Skype VoIP phone module is coupled to the control unit to transmit or receive data through a local area network module. A user motion control module is coupled to the control unit. The display includes multiple display windows including at least one main window and at least one sub-window. A selected program is assigned into the main window. A user control module is coupled to the control unit to allow a user input a command remotely by user figure, finger, vocal, facial or the combination to control a virtual object on the display.

### BRIEF DESCRIPTION OF THE DRAWING

For a better understanding of the present invention and to show how it may be implemented, reference will now be made to the following drawings:

FIG. 1 is a block diagram showing the device of the present invention.

FIG. 2 is a block diagram showing the device of the present invention.

FIG. 3 is a block diagram showing the device of the present invention.

FIG. 4-5 are a block diagrams showing embodiments of the device of the present invention.

FIG. 6 shows a diagram of dual wireless module according to the present invention.

FIGS. 7-10 show a diagram of user motion control module according to the present invention.

FIG. 11 shows a diagram of according to the present invention.

FIG. 12 shows a flow chart according to the present invention.

FIG. 13 to FIG. 13-2 show examples according to the present invention.

FIG. 14 is a block diagram showing one embodiments of the device of the present invention.

FIG. 15, 16A-16C are multiple display windows of the device of the present invention.

FIG. 17, 18A-18B show the ranking module of the present invention.

### DESCRIPTION OF THE PREFERRED EMBODIMENT

The present invention is described with the preferred embodiments and accompanying drawings. It should be appreciated that all the embodiments are merely used for illustration. Hence, the present invention can also be applied to various embodiments other than the preferred embodiments.

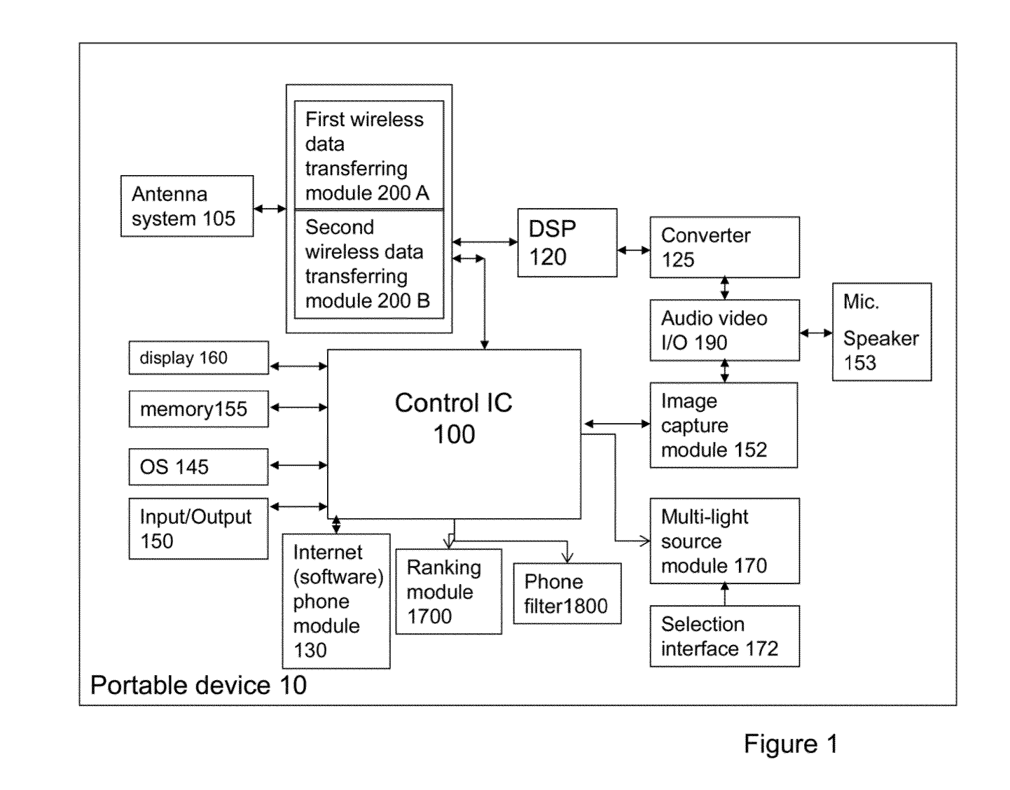

Referring to FIG. 1, it illustrates the functional diagram of the portable device 10 with dual networks capability. The dual way portable terminal 10 with SIM card connector to carry the SIM card, it is well known in the art, the SIM card is not necessary for some other type of cellular such as PHS or some CDMA system. The diagram is used for illustrating and not used for limiting the scope of the present invention. Please refer to FIG. 1. The portable terminal or device 10 includes a first and a second wireless data transferring modules 200A, 200B. The first wireless data transferring module 200A could be video RF module to transmit or receive mobile phone signal and it is well known in the art. As know in the art, the RF unit is coupled to an antenna system 105. The RF module may include base band processor and so on. This antenna is connected to a transceiver, which is used to receive and transmit signal. The first wireless data transferring modules 200A is compatible to the mobile phone protocol such as W-CDMA [symbol] CDMA2000 [symbol] CDMA2001 [symbol] TD-CDMA [symbol] TD-SCDMA [symbol] UWC-136 [symbol] DECT [symbol] 4G system. There systems allow the user communicates with video communication. The RF module may perform the function of signal transmitting and receiving, frequency synthesizing, base-band processing and digital signal processing. The SIM card hardware interface is used for receiving a SIM card. Finally, the signal is send to the final actuators, i.e. a vocal I/O unit 153 including loudspeaker and a microphone. The module 200A, 200B can be formed by separated module (chip) or integrated chip.

The device 10 may include DSP 120, CODEC (not shown) and A/D converter 125 as well. The present invention includes a central control unit 100, a wired input/output) 150, a build-in display 160, OS (operation system) 145 and memory 155 including a ROM program memory, a RAM memory and a nonvolatile FLASH memory. All of the units mentioned above are coupled to the central control unit 100, respectively. The memory could be micro-type hard disc. The wired I/O interface 150 is coupled to the central control unit 100. The wired I/O interface could be USB, IEEE1394. An audio/video I/O 190 is coupled to between the A/D converter 125 and the Mic. and speaker 153.

The device 10 further includes the second wireless data transferring modules 200B. In one embodiment, a wireless local area network (WLAN) module is employed and it could be compatible to the local area network protocol or standard such as Bluetooth standard, Wi-Fi standard, or 802.11x (x refers to a, b, g, n) standard compatible module. Further, the wireless local area network (WLAN) module could be compatible to the WiMAX (Worldwide Interoperability for Microwave Access) standard or specification. An Internet phone module 130 are coupled to the central control unit 100 to allow transmit and receive the audio, video or both type signal to/from the internet network through the wireless local area wireless transmission module. Internet phone module 130 at least meets the standard of terminal-terminal Voice Over Internet Protocol (VoIP). One of the examples is Skype compatible protocol. By using of the Internet phone module 130 and the wireless local area network module 200B, the user may portably, synchronously transmit and receive the vocal, video or both signal through the internet by using the internet (software) phone module 130. The present invention defines a hand-held device having VoIP phone module and wireless WiFi or WiMax network linking module coupled to the VoIP phone module to allow the user to make a wireless terminal-terminal VoIP phone without power on the PC. The voice over internet protocol (VoIP) phone module is used to encode or convert the voice signal into VoIP protocol within the portable communication device before transmitting the signal, followed by programming the signal into WiFi or WiMax format in order to transmit the voice signal through the wireless network, especially, the Skype phone.

As we can see, computing devices are coupled to Internet network, and the computing devices could be but not limited to the Smart TV, tablet PC, notebook, cellular or the smart phone, which are able to access the Internet. The data exchange between the terminals could be implemented directly through the Internet. Apparently, the computing devices includes the terminal-to-terminal VoIP system, such as Skype Phone system or the on-line instant chat system, application or module and from the FIG. 1, the terminals maybe coupled directly by network without the client-server system for the VoIP. Unlike server-client system, the present invention is a terminal-to-terminal system or semi-terminal-to-terminal system rather than a client-server system, and makes use of background processing on computing devices running software. Thus, it may allow the computing device to communicate with other terminals without server-client structure. An image capturing module 152 is required and coupled to the central control unit 100 to catch the video image if the user would like to conduct the real-time video transmission. The image capturing module 152 could be digital still camera, digital video camera. Therefore, the real-time portable conference is possible. In another embodiment, the one difference is that the device may omit the RF module. If the device 10 includes 3G or higher level RF module, the user may transmit the video phone through the air. Therefore, the user may select one of the schemes to make a video call through internet or air depending on the user demand. If the device is within the hot spot area, the user may choose the usage of the internet phone module for communication due to cheaper transmitting fee. If the out of the hot spot range, the other option for video communication is provided. Typically, the WCDMA signal is less restricted by the geography limitation, but the transmission fee is higher. The present invention allows the user to select the proper wireless module for video communication. If the user would like to conduct the video communication through WiFi or WiMax, the method includes coupling to internet or hot spot, followed by activating the internet (software) phone module. Subsequently, vocal signal is input from the speaker and image data is captured from the image capture device, subsequently, the image data and the vocal signal are converted from signal to digital. After the conversion, the image data and the vocal signal are composition, compressed or processed to form a data streams. Therefore, the data may be transmitted to the receiving party seriously. BER of less than about 10.sup.-5 at the channel decoder output is considered desirable for digital music and video transmissions. The bits in a given source coded bit stream (e.g., a compressed audio, image or video bit stream) often have different levels of importance in terms of their impact on reconstructed signal quality. As a result, it is generally desirable to provide different levels of channel error protection for different portions of the source coded bit stream. Techniques for use in providing such unequal error protection (UEP) through the use of different channel codes are described in U.S. patent application Ser. No. 09/022,114, filed Feb. 11, 1998, and entitled “Unequal Error Protection for Perceptual Audio Coders,”. A source coded bit stream is divided into different classes of bits, with different levels of error protection being provided for the different classes of bits.

The device may couple to the internet via the wired data I/O interface or the WLAN module 200 B to upload or download data including digital data such as text format, image format, audio signal, video signal. The wired data I/O interface 150 is coupled to the central control unit 100. The application of the apparatus is quite economical and convenience. Moreover, the user may call other one by the internet phone module to reduce the transmission fee when the local area wireless transmission module detects the signal of the internet network. Otherwise, the user may use the WCDMA for video communication. The portable real-time video conference is possible by implementation of the present invention. Further, the present invention provides dual modes (3G or internet video phone) portable audio/video communication, synchronously.

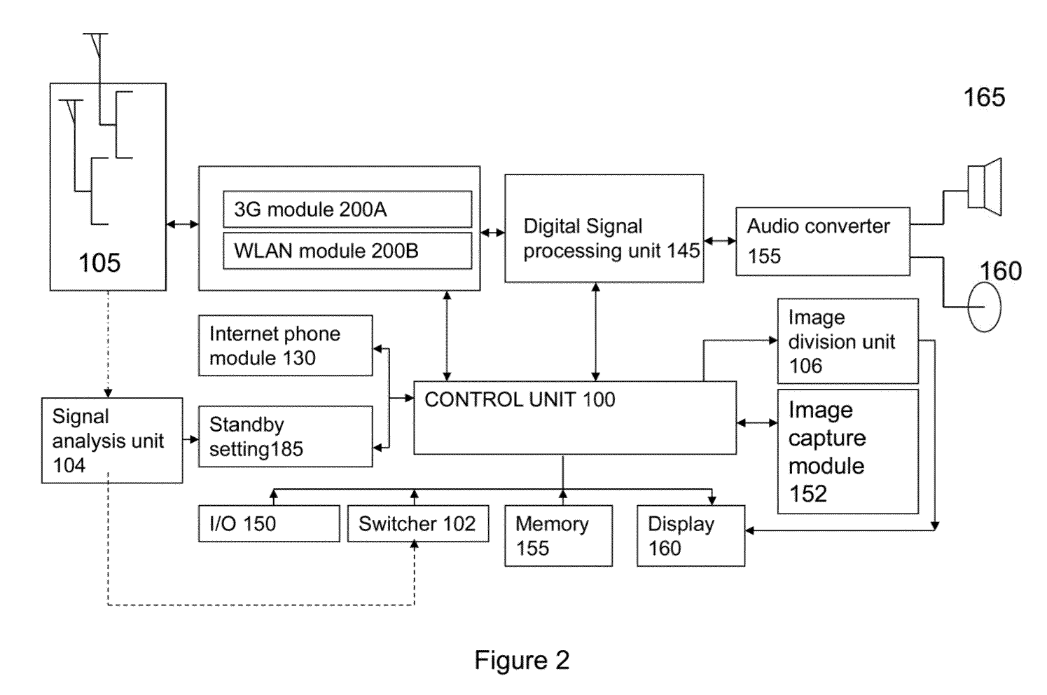

FIG. 2 illustrate alternative embodiment of the present invention, almost of the elements are similar to FIG. 1, the detailed description is omitted. A signal analysis 102 is provided to analysis the signal strength of the dual communication module 200A, 200B. The result will be fed into the module switch 102 to automatically to switch the module or set by manual through the standby setting interface 185. In order to implant the multi-parties video communication, the device 10 includes an image division unit 106 coupled to the control unit 10 to division the displaying area on the display to display the received images synchronicity. Therefore, multi-parties video communication is achieved. The received images will be assigned to the divided displaying area on the display and the displaying areas may be separated, overlap or partial overlap.

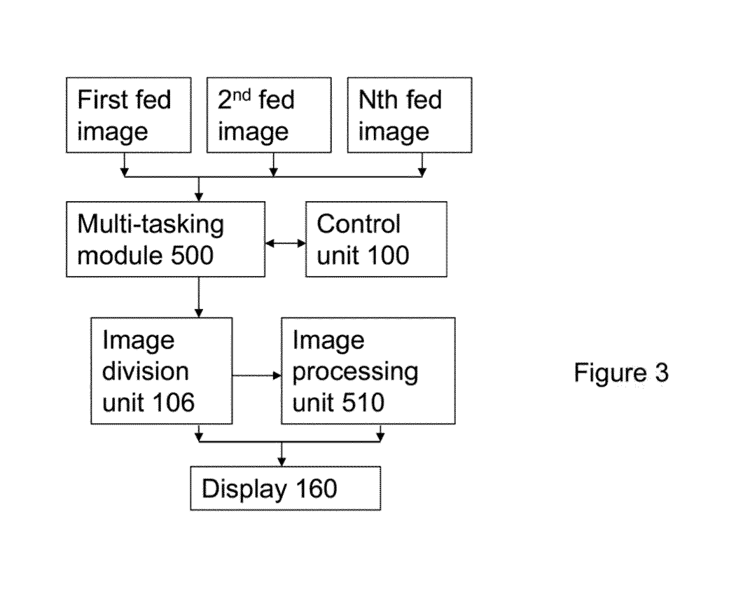

Please turning to FIG. 3, the present invention also includes a multi-tasking module coupled to the control unit as shown in FIG. 3. In computing filed, the multitasking 500 refer to a method where multiple tasks (also known as processes) share common processing resources such as a CPU. In the case of a computer with a single CPU, only one task is to be running at any point in time. Multitasking solves the problem by scheduling which task may be the one running at any given time, and when another waiting task gets a turn. The multi-tasking allow reassign the control unit from one task to another to achieve parallelism or context switches. Thus, the multi-tasking module may reassign the control unit to switch from one process to another different process to facility context switches. For example, a plurality of fed images is transmitted to the multi-tasking module 500 for processing the received images from multi-parties. The images will be processed by the image division unit 106 before sending the image data signals to the display 160. Image processing unit 510 maybe employed to adjust the processed image before displaying. Thus, the multi-tasking module may allow the control unit to process the video image from one party to another party; or adjust the processed image of one party and displaying image of the same party.

The present invention relates generally to a computing or portable device. The device includes but not limited to smart TV, cellular phone, PDA (personal digital assistant), smart phone, notebook, digital still camera, digital video camera, medium player (MP3, MP4), GPS and the equivalent thereof.

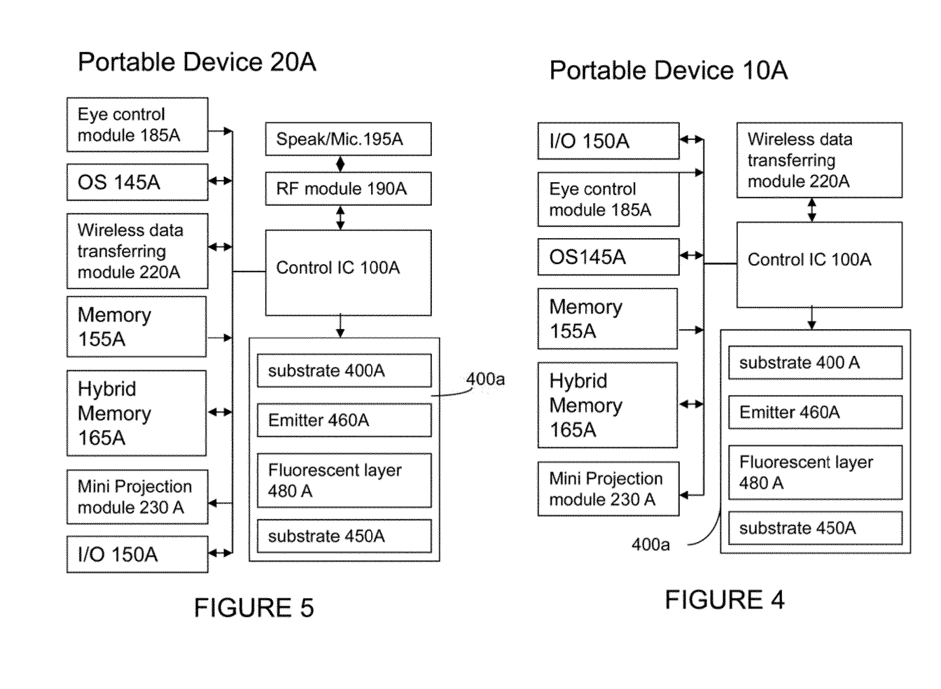

FIG. 4, 5 are diagrams illustrating example of a portable communication device using a panel with emitters and transparent substrate according to an embodiment of the present invention. The device 20A includes a RF module 190A. As known in the art, the RF module 190A includes antenna. This antenna is connected to a transceiver, which is used to receive and transmit signal. AS known, the RF module 190A further includes CODEC, DSP and A/D converter as well. Due to the RF module is not the feature of the present invention, therefore, the detailed description is omitted. Other major components between device 10A and 20A are similar; therefore, the same reference numbers refers to similar component, however, the version, grade and performance maybe different. The present invention includes a central control IC 100A, an input and output (I/O) unit 150A, OS 145A, hybrid memory 165A, the device 10A or 20A may include other memory 155A such as ROM, RAM and FLASH memory. The RF module may perform the function of signal transmitting and receiving, frequency synthesizing, base-band processing and digital signal processing. If the portable device is cellular, SIM card hardware interface is provided for receiving a SIM card. Finally, the signal is send to the final actuators, i.e. a loudspeaker and a microphone 195A or I/O 150A.

The present invention further includes a wireless transmission/receiving module 220A coupled to the control IC 100A. The transmission/receiving module is compatible with blue-tooth, home-RF, 802.11x, WiFi, WiMAX standard or their higher version. The transmission domain (the air) by nature is not secured and therefore encryption maybe essential in the wireless transport networks. In one embodiment, pair-wise encryption/decryption between every neighboring wireless network device of a wireless transport network is well-known in the art. A data frame that leaves from one wireless device from one end of a wireless transport network to the other end of the same network might need several encryptions and decryptions before it reaches its final destination.

The devices include an antenna located within the portable device, the signal receiving performance is poor due to EM shielding effect generated by the shield, circuits, circuit board and other components. If the antenna to the signal is “transparency”, the performance will be improved. Therefore, in another aspect of the present invention is to provide an antenna located corresponding to a substantially transparent panel to minimize the EM shielding effect, thereby improving signal receiving/transmitting performance. Preferably, at least one transparent antenna is attached on the substantially transparent panel to minimize the EM shielding effect.

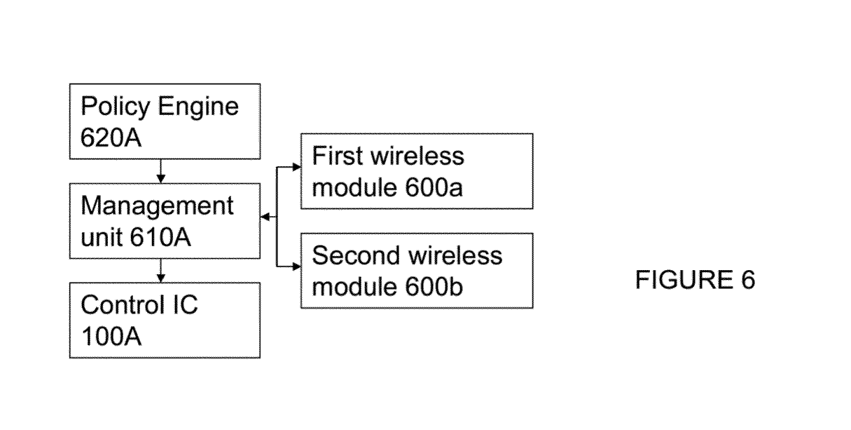

In another embodiment, the wireless data transferring module 220A includes dual mode module. Please refer to FIG. 6, in one case, the wireless data transferring module 220A includes a first and second wireless module 600a and 600b for wireless transmission. The dual modules 600a and 600b are coupled to a management unit 600A to manage the dual modules according to the policy set in a policy engine 610A. For example, the policy in the policy engine 610A includes at least the transmission priority policy to determine which module will be the default module to receive/transmit data. It also includes the switching condition for switching there between. For example, the signal strength is one of the facts for switch condition. It also allows the user to set or alter the condition via user interface. The first and second wireless module maybe one of the following module: blue-tooth, 802.11x, WiFi, WiMAX, 3G, 4G standard or their higher (update) version. Preferably, the first wireless module is WiFi and the second wireless module is WiMax. The present invention may yield the benefits of both. For example, the access range of WiFi is shorter than WiMax, but it consumes lower power. If within the office area, the AP for WiFi may be employed to prevent others outside the office from accessing the server of the office. In another aspect, if the user would like to access or remote control a terminal device located at several miles away, the WiMax is chosen. The WiFi benefits security, low power consumption while WiMax yields long range and high bandwidth. The module architecture refers to dual wireless module (DWM). The DWM has the benefits of the both type of module. The first wireless module is compatible to a first communication protocol, while the second one is compatible to a second communication protocol. The manufacture may increase the performance by incorporating the two kind of wireless module memory with an optimized configuration. The protocol maybe adapted to wireless local area network or wireless mediate area network.

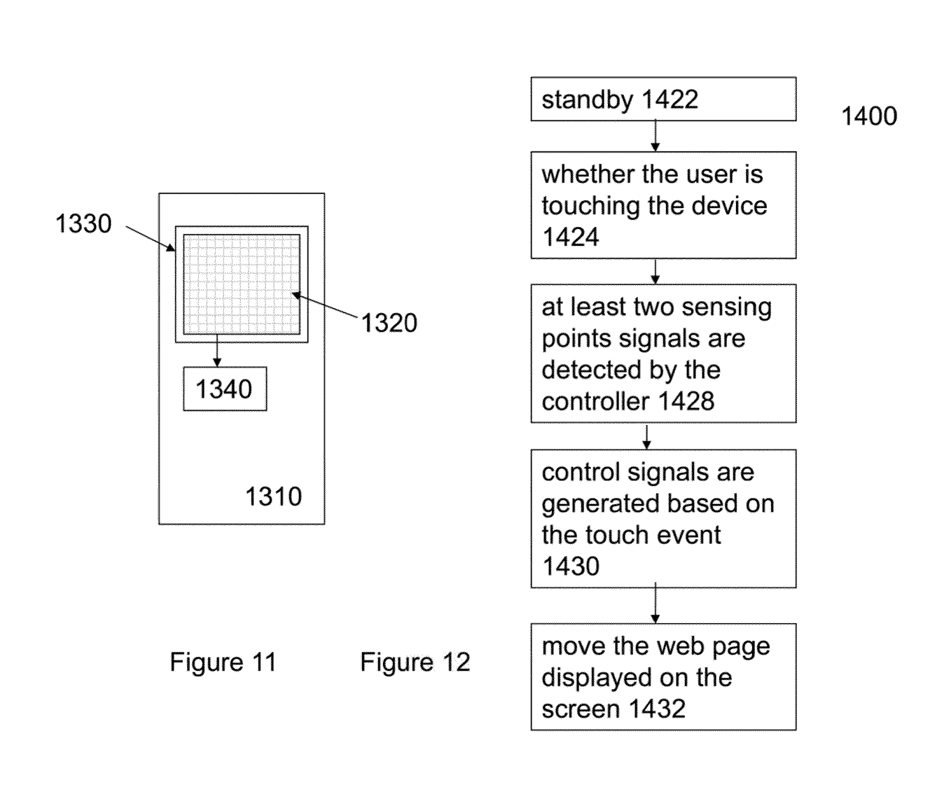

The present invention also provides a user control module to control the virtual object without mouse or touchpad. A computing device comprises a display and a detecting device for detecting motion of a user. A movement information generating device is in responsive to the detection to generate an output signal, thereby generating movement information. A cursor control module is in responsive to the movement information to drive a cursor on the display corresponding to the movement information. Referring now to the drawings 7-10, there is shown in schematic form the basic components of the control module 185A incorporating the eye, figure, finger or face control module according to a preferred embodiment of the invention. The present invention includes a step of detecting the motion of a user. Preferably, the portion for detection could be eye, face or the like. The eye detection will be introduced as one of the examples to illustrate the features of present invention. The subject's face or eye is positioned relative to a sensor so that initially the subject's gaze is aligned along center line toward a pupil stimulus and fixation target. The eye control module 185A includes sensor and IC to detect eye motion and generate a control signal. The face motion could be used to practice the present invention. A detecting source 18505 is provided, the pupil of the eye(s) is (are) illuminated by the light source 18505, for example, an infrared ray (IR) or light emitting diode (LED). Preferably, dual source LED is used to project two spatially separated spots at the subject's pupil. The dual source LED is constructed by placing two LED side by side on the panel 400a of the portable device. Back light from the subject's eye is detected by a sensor 18510 directly or via other optical mirror or lens. Another method is to detect the user face motion or image by the sensor. The sensor 18510 could be optical sensor such as CMOS sensor or CCD. The outputs from the sensor 18510 are input to a processor or control integrated circuits 18515 to generate a control signal to a cursor control module 18520 for controlling a cursor on the display or panel. Preferably, the detecting source or the like scans the position of the pupil of eye(s). In this process the pupil is illuminated by a light source, so that the geometric form of the pupil can be portrayed clearly on the sensor. Alternatively, the image (face) change of the user could be detected by the present invention. By means of image processing, the pupil position information is evaluated and to determine where the eye in the display is looking. The control signal may drive the cursor to the position where the eyes are looking through cursor control module 18520. A buttons-image (or button-icons) may be generated along with the cursor by an image generator 18525. In one case, the image generator 18525 maybe a touch screen module which may generate touch screen image via well-known touch screen technology, in the manner, the user may “click on” the virtual bottom to input a command by means of “clicking” the touch screen. Alternatively, the click signal maybe input from input interface 18540 such as (the right and left buttons of) the keypad, vocal control through microphone, eye motion through the sensor 18510. In the case of vocal control, another software/hardware maybe necessary to process the steps of object selection through voice recognition hardware and/or software. For example, the action of close left eye refers to click left button while the action of close right eye refers to click right button. If both eyes close, it may refer to select one item from a list. The above default function may be practiced by a program and software. It should be understood by persons skilled in the art, the foregoing preferred embodiment of the present invention is illustrative of the present invention rather than limiting the present invention. Modification will now suggest itself to those skilled in the art. Under the method disclosed by the present invention, the user may move the cursor automatically without the mouse. Similarly, the control signal may be used to drive the scroll bar moving upwardly or downwardly without clicking the bar while reading document displayed on the screen, as shown in FIG. 11. Thus, the control signal generated by IC will be fed into the scroll bar control module 18550 to drive the scroll bar 18555 on the display moving upwardly or downwardly without the mouse or keypad. An eye controllable screen pointer is provided. The eye tracking signals are performed in a calculation by a processing means residing in a processor or integrated circuits to produce a cursor on the screen.

The sensor is electrically coupled to the controller (IC) 18515 via line. In a preferred embodiment, input controller 18515 comprises a semiconductor integrated circuit or chip configured to receive, interpret and process electrical signals, and to provide output electrical signals. Output signals from IC 18515 comprise signals indicative of movement of eye in a direction corresponding to the direction of actual cursor movement on the display intended by the user. The present embodiment takes into account a possible “dragging” situation that the user may be faced with. On occasion, some users have a need to “drag” an icon or other object from one area of the screen to another. On some computers, to accomplish this, the user must hold down the left click button and control the pointing device at the same time. If a touchpad is being used as the pointing device, and the object must a dragged a long distance across the screen, sometimes the user's finger may reach the edge of the touchpad. This situation is easily handled by the present invention. In such a situation, the controller may send the command (e.g. “click left mouse button”, while dragging) repeatedly until the user's finger leaves a keyboard key (stops pressing a key).

Therefore, the present invention providing a method of pointing a mark such as cursor, bar on a screen, or moving virtual object on the screen, the method includes detecting motion of a user (such as eye, figure, finger, face motion) and a sensor is in responsive to the detection of the motion of a user (such as eye, figure, finger, face motion) to generate an output signal, thereby generating motion of a user (such as eye, figure, finger, face motion) or user movement information; A virtual object control module is in responsive to the user movement information to drive a virtual object on the display corresponding to the movement information.

As aforementioned, the present invention discloses a user motion control module for computing device or portable device. The module could be incorporated into the device adjacent to the keypad or keyboard area. Then, it may detect the figure motion of the user to move the virtual object. Under some embodiments, the CMOS or CCD is used to detect the user motion including the facial expression, facial motion, or finger motion. In these applications, the sensor may capture the images and the controller may analysis the image change, thereby determining the virtual object movement. The monitoring of and response to the user's facial expressions may also be used, for example, the user's motion could be monitored with a still camera or a video camera. It is unlike the conventional track ball, control panel for notebook. It should be noted, in the embodiment, the user motion detecting module is set adjacent to the keypad of notebook, or keyboard of the PC. The user motion detecting module detects the figure motion of the user by CMOS, CCD as aforementioned method. The resolution of the CMOS sensor may achieve higher than several Mega pixels. It may precisely reflect the finger (or face) motion of the user.

Alternatively, the cursor or items or function of computer (such as open file, close file, copy, cut, paste, etc.,) may be controlled by the user activity, such as through the measurement of the activity of the human brain. The EEG (electroencephalograph) records the voltage fluctuations of the brain which can be detected using electrodes attached to the scalp. The EEG signals arise from the cerebral cortex, a layer of highly convoluted neuronal tissue several centimeters thick. Alpha waves (8-13 Hz) that can be effected if the user concentrates on simple mentally isolated actions like closing one's eyes; Beta waves (14-30 Hz) associated with an alert state of mind; Theta waves (4-7 Hz) usually associated with the beginning of sleep state by frustration or disappointment; and Delta waves (below 3.5 Hz) associated with deep sleep. Electromyographic (EMG) sensors are attached to the person's skin to sense and translate muscular impulses. Also Electrooculargraphic (EOG) signals have been sensed from eye movement. U.S. Pat. No. 7,153,279, assigned to George Washington University disclosed a brain retraction sensor. U.S. Pat. No. 7,171,262, assigned to Nihon Kohden Corporation disclosed a Vital sign display monitor. The neural activity is tracked on neural activity detecting device 350. Preferably, the neural activity tracked includes EEG, EOG, EMG activity. The electrical signals representative of the neural activity are transmitted via wired or wireless to the control unit. If a predetermined signal is sensed by detecting device, the same EEG readings may be monitored. For example, the Alpha waves (8-13 Hz) can be effected if the user concentrates on some actions. Thus, if the concentration pattern is detected, the system is responsive to the signal and issue an instruction to take action to “open file”, “close file”, “copy file”, “clicking”, “paste”, “delete”, “space”, or “inputting characteristics” etc. It should be noted that the state patterns of potential users may be monitored before the system is used.

The control IC 18515 is coupled to a signal receiver (not shown) which receives the neural signals from sensor 18510 by antenna or wired. An operating system runs on CPU, provides control and is used to coordinate the function of the various components of system and Application programs 18560. These programs include the programs for converting the received neural electrical signals into computer actions on the screen of display. By using the aforementioned devices, a user is capable of controlling the computer action by inputting neural information to the system through sensor. There will be described the setting up of a program according to the present invention for a user controlling a computer with sensed neural signals. A program is set up in the computer to use the electrical signals to control computer functions and/or functions controlled by the computer. A process is provided for predetermining the neural activity level (or pattern) that indicates the level of concentration of the user. A sensor is provided for monitoring a user's neural activity to determine when the predetermined neural activity level has been reached. The user's EEG pattern is determined. The user's neural activity is converted to electrical signals, and to give an instruction to execute a software functions. Before the user EGG pattern is determined, an image sensor (CCD or CMOS) is introduced to monitor the facial motion (or eye motion) to determine where the user looks at on the screen.

Therefore, the present invention discloses a method of controlling a virtual object by user motion for a computing device comprising: detecting a user motion by detecting device; generating a control signal in responsive to the user motion detection; and controlling the virtual object such as cursor displayed on a display in responsive to the control signal. The user motion is detected by CMOS or CCD and the user motion includes facial motion, eye motion, or finger motion. The method further comprises a step of analysis the user motion before generating the control signal. The analysis includes the analysis of image change of the user motion.

A method of instructing an object by user activity for a computing device comprises detecting a user activity by a detecting device; generating a control signal in responsive to the user activity detection; controlling the object displayed on a display in responsive to the control signal to execute the instruction. The user activity is detected by CMOS or CCD and the user activity includes facial motion, eye motion, figure motion or finger motion. The analysis includes the analysis of image change of the user. Alternatively, the user activity is detected by EEG, EMG, or EOG sensor. The control signal includes cursor movement, character input, software application instruction.

A method of instructing an object by user activity for a computing device comprises detecting a user motion by a detecting device by CMOS or CCD; generating a control signal in responsive to the user motion detection; controlling the object displayed on a display in responsive to the control signal; detecting a EEG, EMG, EOG pattern by a EEG, EMG, EOG sensor to execute an instruction.

FIG. 11 is a simplified diagram of a portable electronic device 1310, in accordance with one embodiment of the present invention. The portable electronic device 1310 may for example be a hand held electronic device such as cellular phones, PDAs, media players, and GPS, or notebook, Tablet PCs and game players. The portable electronic device 1310 is configured with a sensor array on the display. The sensor array 1320 is configured to detect the presence of an object such as a finger as well as the location and pressure being exerted on the surface of the panel by the finger or palm of the hand. By way of example, the sensor array 1320 may be based on capacitive sensing, resistive sensing, surface acoustic wave sensing, thermal sensing and/or the like. The sensor array 1320 may further be based on pressure sensing such as strain gauges, force sensitive resisters, load cells, pressure plates, piezoelectric transducers or the like.

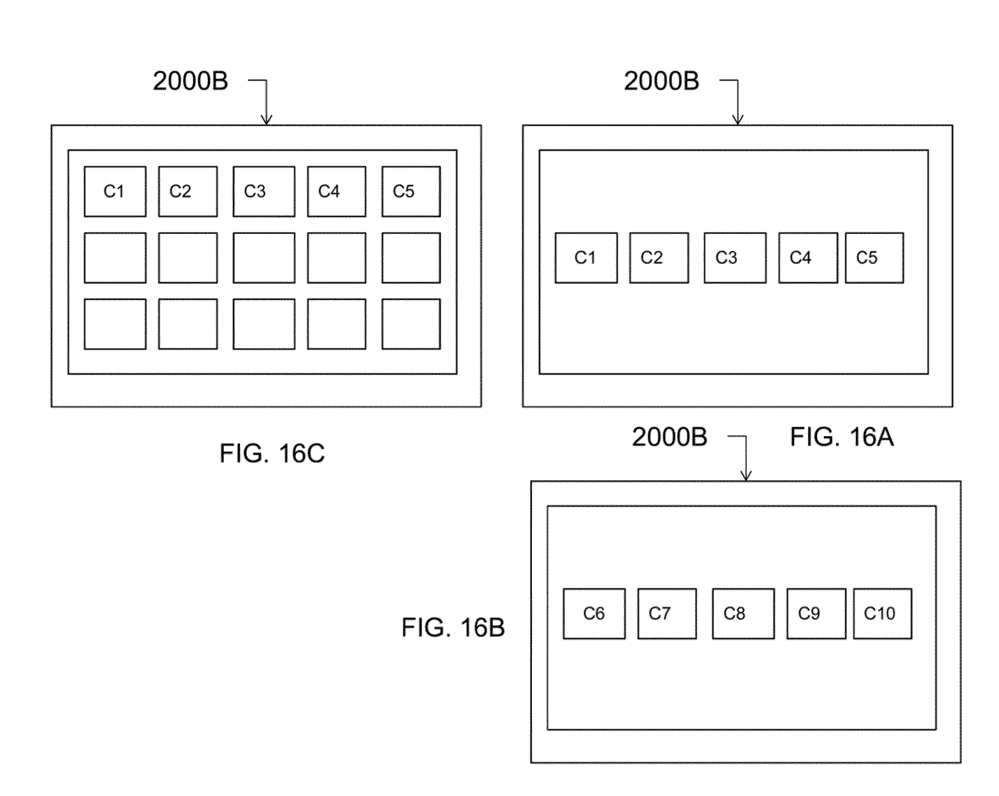

As shown in FIG. 11, the portable electronic device 1310 includes a housing and a display 1330 situated in a front surface of the housing. The portable electronic device 1310 also includes a touch sensing device 1320 is situated on the display. FIG. 15 is a perspective diagram of a hand held electronic device 1310, in accordance with one embodiment of the present invention. The hand held electronic device 1310 includes a housing that encloses internally various electrical components including integrated circuit chips. For example, the housing may contain a microprocessor (e.g., CPU), memory (ROM, RAM), a power supply (e.g., battery), a printed circuit board (PCB), a hard drive or other memory (e.g., flash) and/or various input/output (I/O) support circuitry. The hand held electronic device 1310 also includes a display 1330 disposed within and viewable through an opening in the housing. The display 1330 is typically placed on the front surface of the device 1310. The display 1330 provides visual information in the form of text, characters or graphics. For example, the display 1330 may correspond to a liquid crystal display (LCD), organic light emitting diodes (OLED), or a display that is based on electronic inks, electronic paper.

In order to generate user inputs, the hand held electronic device 1310 may include a sensing array 1320 that is a transparent input panel positioned in front of the display 1330. The sensing array 1320 generates input signals when an object such as a finger is moved across the surface of the sensing array 1320, for example linearly, radially, rotary, etc., from an object holding a particular position on the array 1320 and/or by a finger tapping on the array 1320. In most cases, the sensing array allows a user to initiate movements in a GUI by simply touching the display screen via a finger. For example, the sensing array 1320 recognizes the touch and position of the touch on the display 1330 and an interpreting controller 1340 of the hand held electronic device 1310 interprets the touch and thereafter performs an action based on the touch event. In accordance with one embodiment, the sensing array 1320 is a multi-touch sensing device that has the ability to sense multiple points of contact at the same time and report the multiple touches to the controller of the handheld electronic device. In one implementation, the sensing array 1320 is a multipoint capacitive touch screen that is divided into several independent and spatially distinct sensing points, nodes or regions that are positioned throughout the display. The sensing points, which are typically transparent, are dispersed about the sensing array with each sensing point representing a different position on the surface of the display. The sensing points may be positioned in a grid or a pixel array where each pixilated sensing point is capable of generating a signal. The signal is produced each time an object is positioned over a sensing point. When an object is placed over multiple sensing points or when the object is moved between or over multiple sensing point, multiple signals can be generated. The sensing points generally map the touch screen plane into a coordinate system such as a Cartesian coordinate system or a Polar coordinate system. An example of a multipoint capacitive touch screen may be found in U.S. patent Ser. No. 10/840,862, which is herein incorporated by reference.

The hand held electronic device 1310 may be designed to recognize gestures applied to the sensing array 1320 and to control aspects of the hand held electronic device 1310 based on the gestures. The gestures may be made through various particularly finger motions. The hand held electronic device 1310 may include a gesture operational program, which may be part of the operating system or a separate application.

In one embodiment, the sensing input device is mapped to the display. When mapped, points on the sensing input device coincide with points on the display, i.e., have the same coordinates (x and y). Therefore, when a user touches the sensing input device surface, it will appear as if the user is touching the image at the same location of the display. As shown, the sensing array 1320 is divided into several independent and spatially distinct sensing points (or regions) that are positioned within the respective component. The sensing points are generally dispersed about the respective component with each sensing point representing a different position on the surface of the component and thus the device 10. The sensing points may be positioned in a grid or a pixel array where each pixilated sensing point is capable of generating a signal. The number and configuration of the sensing points may be widely varied. The number and configuration of sensing points generally depends on the desired resolution of the touch sensitive surface and may be varied from spot to spot across the display to achieve any desired compromise between cost and functionality. In the case, a signal is produced each time the finger is positioned over a sensing point. When an object is placed over multiple sensing points or when the object is moved between or over multiple sensing points, multiple position signals are generated. As should be appreciated, the number, combination and frequency of signals in a given time frame may indicate size, location, direction, speed, acceleration and the pressure of the finger or palm on the surface of the device. By way of example, the control system may be a microcontroller located within the housing of the device 1310.

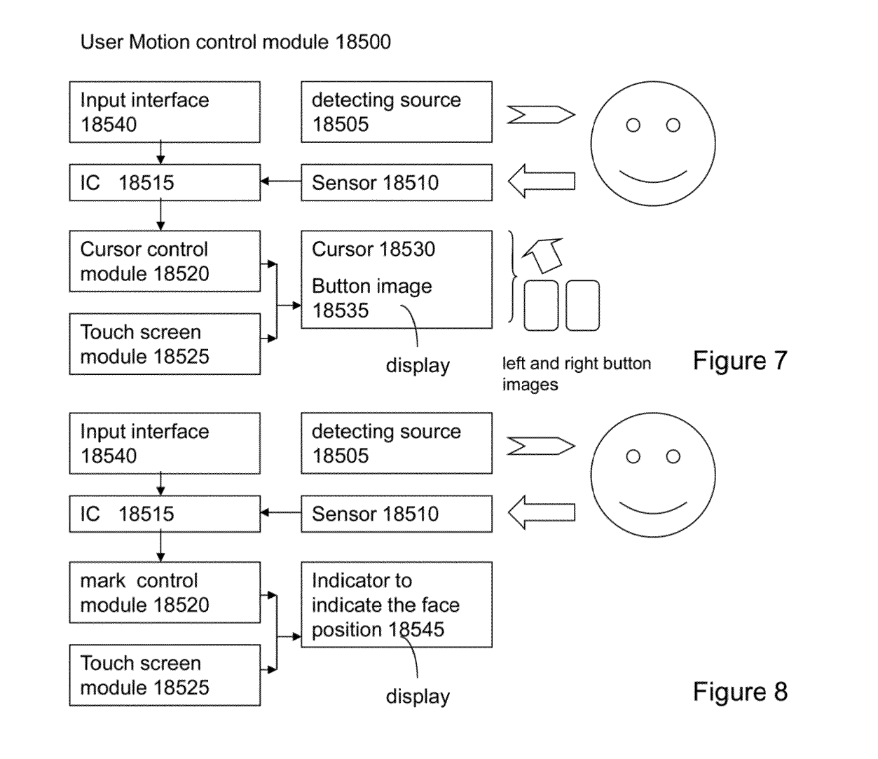

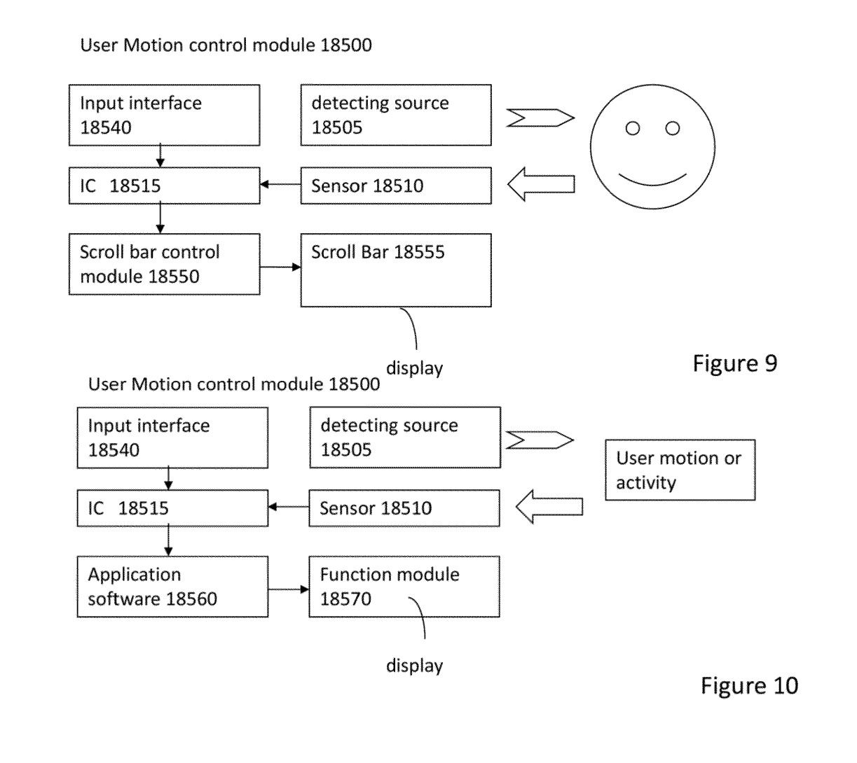

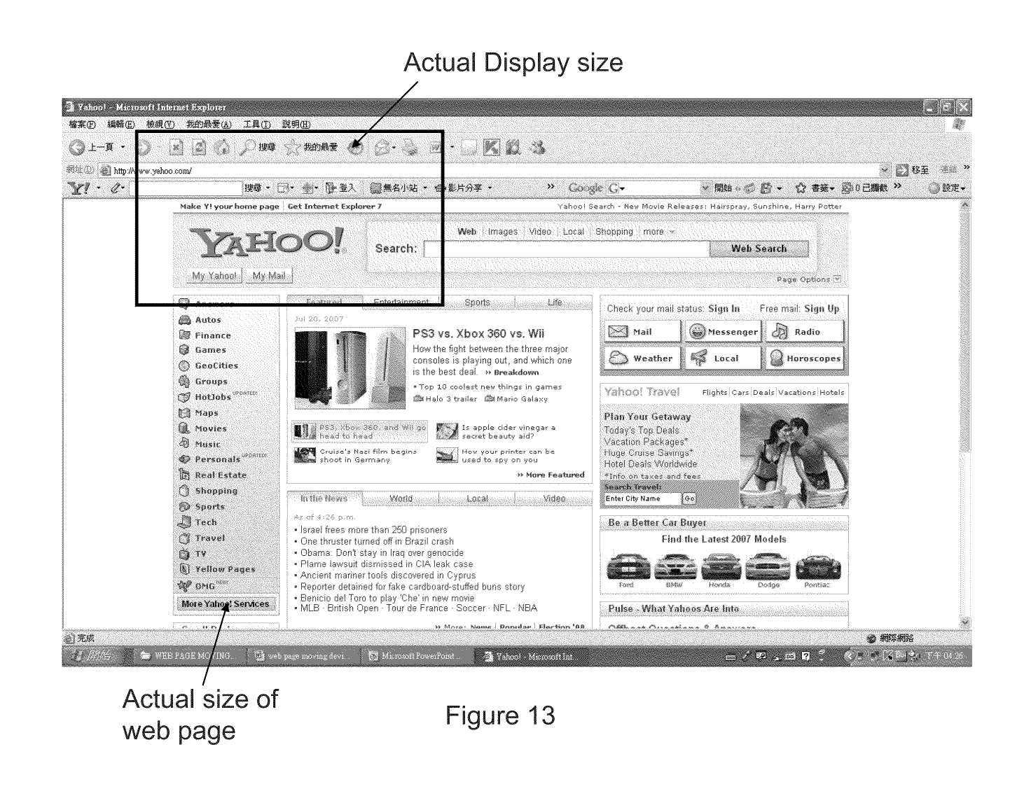

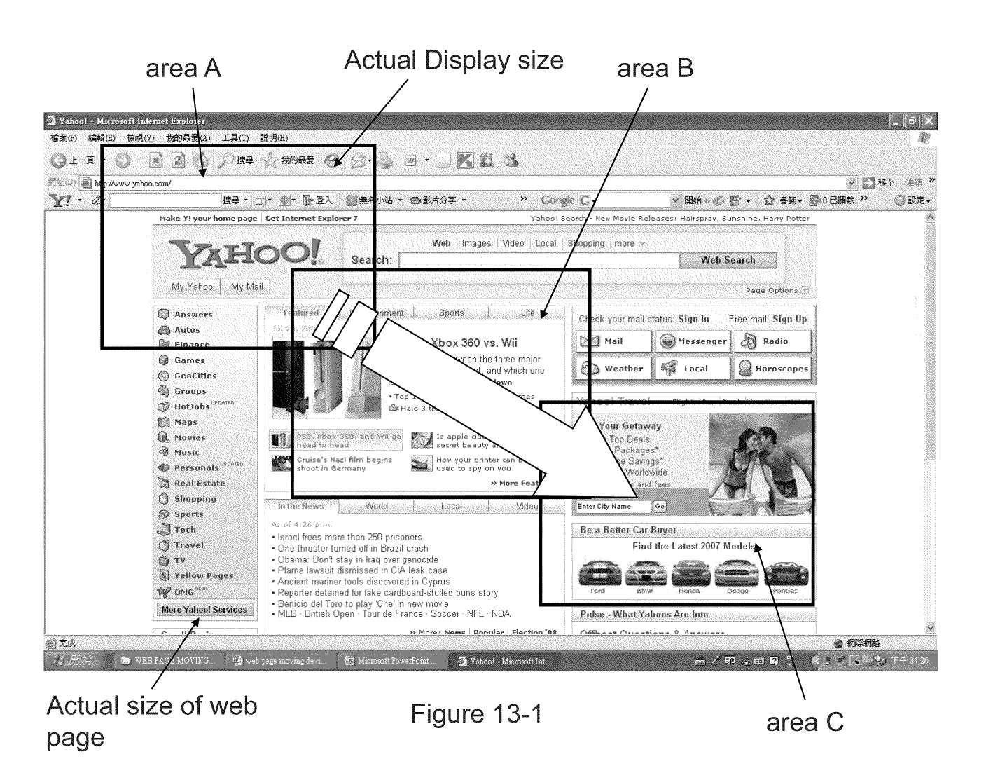

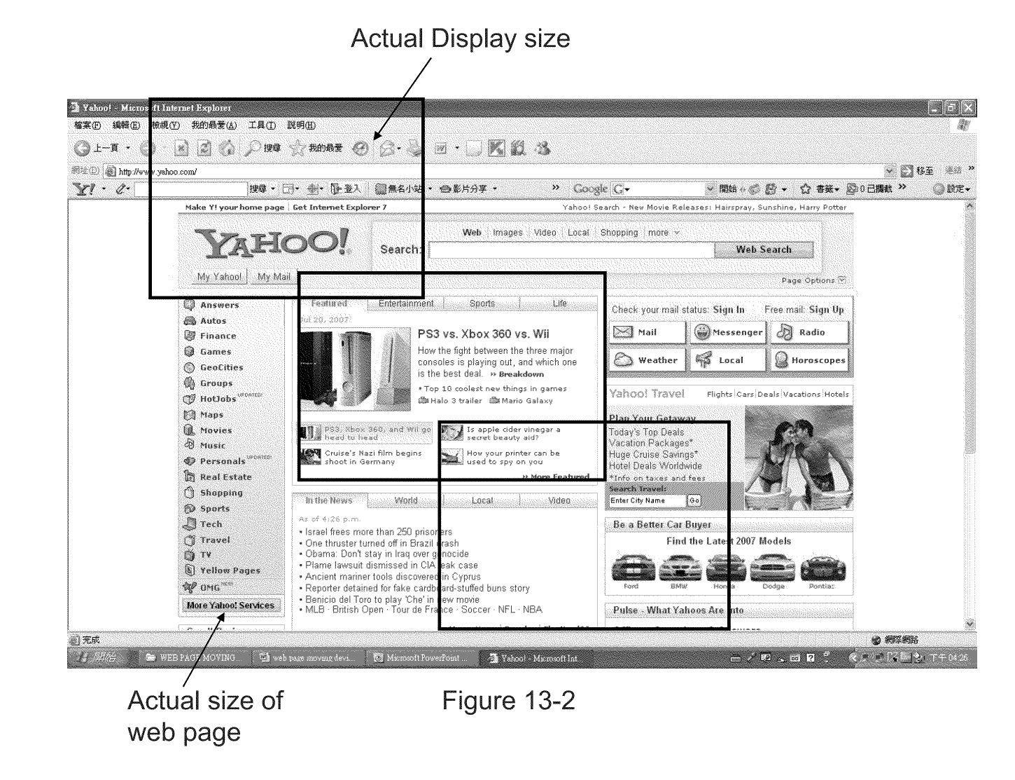

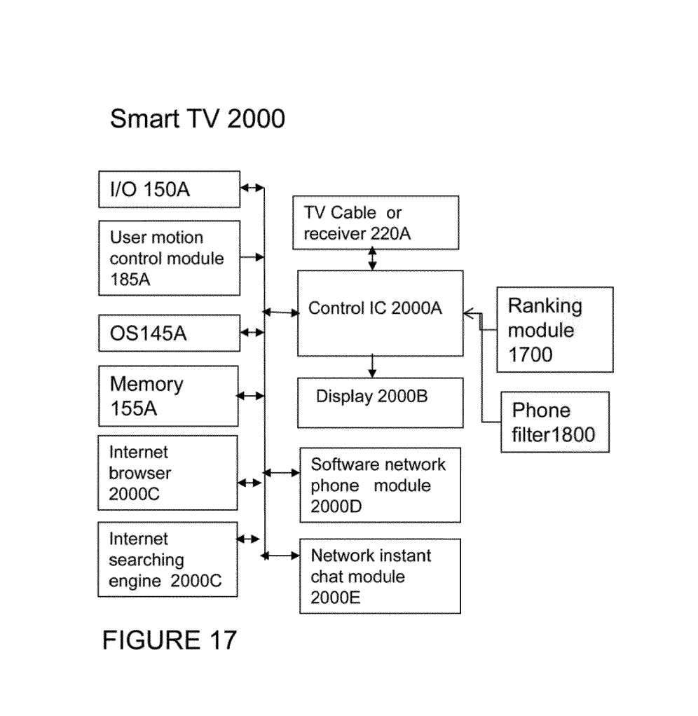

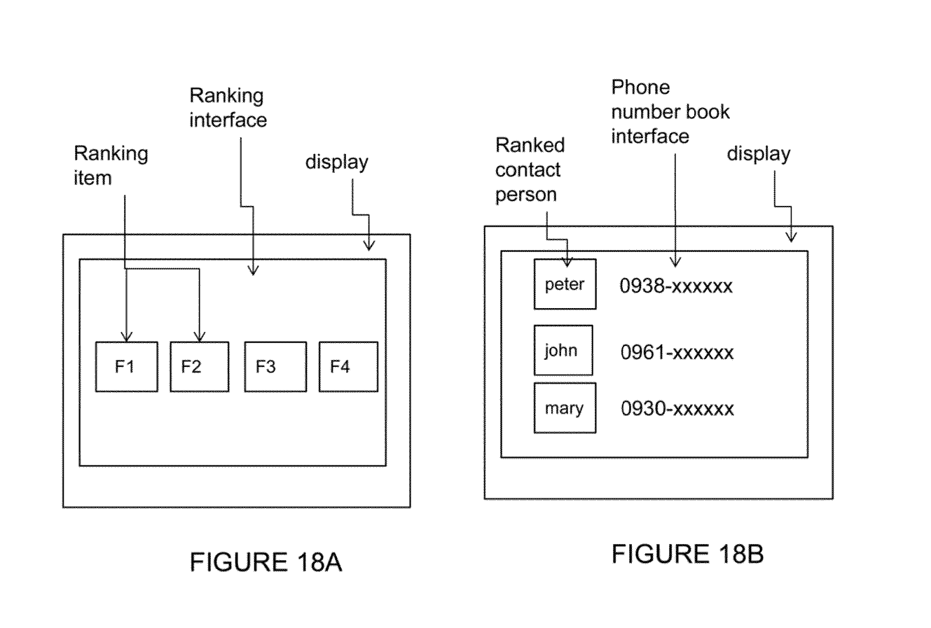

The signals generated at the sensing points may be used to determine how the user would like to move the web page displayed on the display. For example, each portion of the hand in contact with the device produces a contact patch area. Each of the contact patch areas covers several sensing points thus generating several signals. The signals may be grouped together to form a signal that represents how the user is moving the web page. In one embodiment, the difference between a current signal and a last hand signal may indicate the user's desire to implement a function of moving web-page. A significant difference indicates the user's desire to implement a function. Changes between contact patch areas may further indicate the particular moving signal. In mapping, the touch surface is divided into one or more button zones that represent regions of the device that when selected implement the particular button function associated with the button zone. The button zone having the contact patch area with the most significant change between first and second hand signals is the one that is typically implemented. The position and size of the button zones may also be customizable. For example, page back, page next and so on. The customization may be performed by the user and/or the device. It is because that the display is too small, the whole web page (or text, image) cannot be seen and displayed by the display, as shown in FIG. 17. The display of PC may browser the almost the full page of the web information, however, it cannot achieve the purpose by the portable device with small display. From FIG. 17, the user may only browser a part of the “actual web page”, not full page of the web information due to the limitation of the size of the display. The other area outside the actual display window indicated in the FIG. 13 cannot be viewed by the user. Conventionally, the user should click the scroll bar or keys to scroll the web page (or text, image, email) back and forth, right and left. It is very inconvenient to the user and the convention method is not user friendly design. However, the present invention provides the solution. The user may move his finger on the screen to introduce a user (or finger) movement for indicating where the user would like to view. For example, the user may move his finger and the movement is indicated by the arrow from area A to area C through area B to browse the part (area C) of the web page, as shown in FIG. 13-1. Thus, the user may move his figure on the display to review anywhere of the web page (image or text) while the display is too small, especially for the portable device, as shown in FIGS. 13-1 to 13-2.

FIG. 12 is an operational method in accordance with one embodiment of the present invention. The method 1420 generally begins at block 1422 where the device is in standby. Standby generally implies that the device is in a state of readiness waiting for something to happen, i.e., a user initiating an action therewith. Following block 1422, the process flow proceeds to block 1424 where a determination is made as to whether the user is touching the device. This is generally accomplished with touch sensing device capable of generating signals when a hand nears the device and a control system configured to monitor the activity of the touch sensing device. If it is determined that the user is not touching the device, then the process flow proceeds back to block 1422 thereby keeping the device in standby. If it is determined that the user is touching the device, then the process flow proceeds to block 1426 where the user is determined.

In one embodiment, once the second location is determined, the process flow proceeds to block, at least two sensing points signals are detected by the controller. Following block 1428 the process flow proceeds to block 1430, where touch events are monitored, control signals are generated based on the touch event. The control signals 1432 may be used to inform the application software within the device to move the web page displayed on the screen instead of by moving the web page by scroll using keys, cursor or touch pen.

The processor can be implemented on a single-chip, multiple chips or multiple electrical components. For example, various architectures can be used for the processor, including dedicated or embedded processor, single purpose processor, controller, ASIC, and so forth. In most cases, the processor together with an operating system operates to execute computer code and produce and use data. The operating system may correspond to well-known operating systems such as OS/2, DOS, Unix, Linux, and Palm OS. Memory provides a place to store computer code, the memory may include Read-Only Memory (ROM), Random-Access Memory (RAM), hard disk drive, flash memory and/or the like. The display is generally configured to display a graphical user interface (GUI) that provides an easy to use interface between a user of the electronic device and the operating system or application running thereon. The electronic device also includes a touch screen that is operatively coupled to the processor. The touch screen is configured to transfer data from the outside into the device. The electronic device also includes a sensing device that is operatively coupled to the processor. The sensing device may also be used to issue web page moving commands.

Examples of devices include smart TV, tablet, PDAs, cellular, smart phone, Media player, game players, cameras, GPS receivers and the like. Therefore, the user may move the web page, image or document displayed on the page by directly moving the finger on the sensing array. The user may move the web-page, text, image, icon shown on the display directly by hand or user finger.

A further embodiment of the present invention uses a relatively semiconductor devices take of the finger images as many as 1,500 pictures per second to replace the touch sensing array. A complimentary metal-oxide semiconductor (CMOS) sensor captures the motion of the finger and the sensor sends each image to a digital signal processor which is able to detect changes in pattern in the images. CCD could be used to process the function. Based on the changes in pattern over a sequence of images, the processor determines how far the finger has moved on the surface of the mouse and sends the coordinates to the computer which moves the cursor or image based on the coordinates received from the mouse. A CMOS mouse may therefore provide improved tracking resolution, is devoid of moving parts and may be suitable for use on a variety of different surfaces.

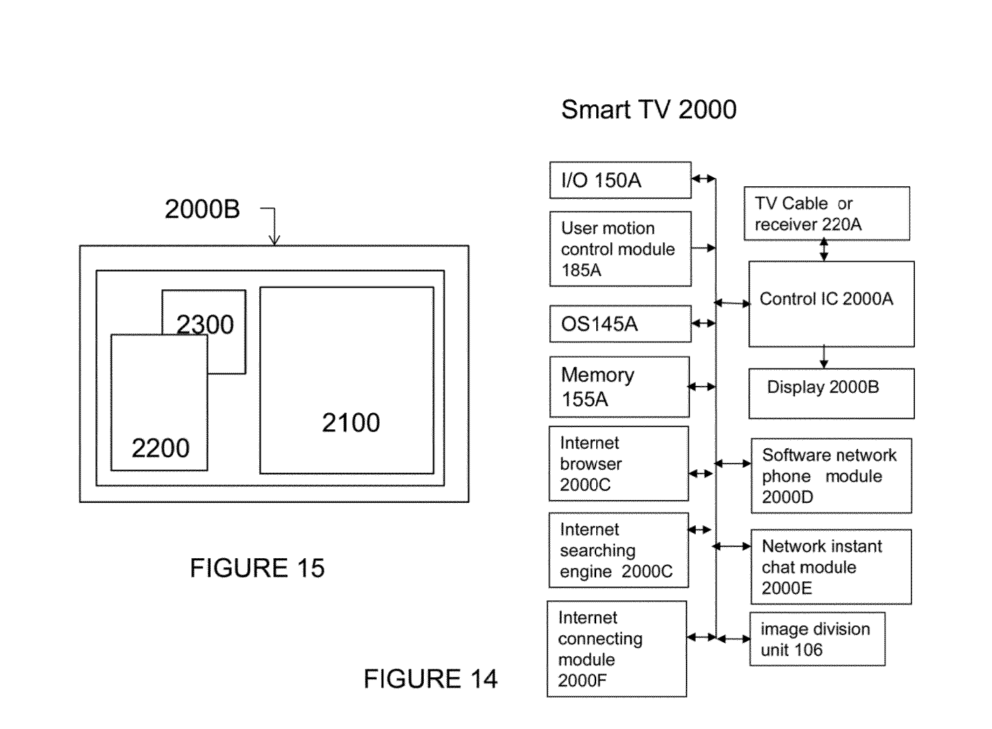

Please refer to the embodiment of smart TV which may include at least one or all of the above features of aforementioned embodiments. The smart TV as shown in FIG. 14 includes the controller 2000A and a display 2000B. The user motion control module 185A is illustrated as above, therefore the detailed is omitted. The TV also include the TV cable or receiver to input the TV program signal, the tuner and the IR remote control receiver are also necessary, but do not shown on the diagram. The TV also includes the browser 2000C and the network phone module 2000D to allow the user to browse the website, portal, facebook, blog or to conduct the network phone through the TV, an internet searching engine 2000C allows the user couple to the internet through the internet connecting module 2000F. A Network instant chat module 2000E is also implanted into the TV for the instant on-line chat with other user through the TV.

The embodiment also includes a multi-tasking module coupled to the control unit as shown in FIG. 5. The multi-tasking allow reassign the control unit from one task to another to achieve parallelism or context switches. Thus, the multi-tasking module may reassign the control unit to switch from one process to another different process to facility context switches. For example, a plurality of fed images is transmitted to the multi-tasking module 500 for processing the received images from multi-parties. The images will be processed by the image division unit 106 before sending the image data signals to the display 160. Image processing unit 510 maybe employed to adjust the processed image before displaying. Thus, the multi-tasking module may allow the control unit to process the video image from one party to another party; or adjust the processed image of one party and displaying image of the same party. As aforementioned embodiment, the TV 2000 may includes an image division unit 106 (also shown in above embodiments) coupled to the control unit 2000A to division the displaying area on the display to display the received images synchronicity. Therefore, multi-display is achieved as shown in FIG. 15. The received TV program will be assigned to the divided displaying area, such as main display 2100 on the display; the user interface of browser 2000C, the network phone module 2000D, or the network instant chat module 2000E may be assigned to the other divided window display such as sub-display 2200. The assigned window maybe altered by user command such as user figure or hand motion, vocal command or facial express as mentioned above. Therefore, the TV program may be switched to the sub-display; and at least one of the interface of the browser, website, the instant chat module or interne phone module may be displayed on the main display window. The present invention may allow the user chat, call the others or browse website while watching the TV program. The other window display may be used for displaying the advertisement at the same time on the residual sub-display 2300. The user interface of the instant chat module or the network phone module maybe includes the live video of the at least two parties. The user himself maybe displayed on the sub-window display 2200 and the other party is displayed on the sub-window display 2300. The displaying areas may be separated, overlap or partial overlap. The user may alter the arrangement by user figure, finger, hand, vocal control, or facial control. The embodiment maybe employed by the smart phone or tablet computing device.

FIG. 16A-FIG. C show the multiple-windows on the display 2000B. The multiple windows displays the preview of each channels broadcasted from the service stations. For example, please refer to the FIG. 16A, the display includes multiple windows and they are configured with a band structure. The user may use the aforementioned remote control by using the figure, finger, facial, vocal, eye or the combination to remotely control the display of the channels. For example, the user may change the pre-view page on the display by gesture, then the another preview page with another multiple channels will be displayed on the multiple windows as shown in FIG. 16B. The multiple preview windows may be arranged as the matrix form as shown in FIG. 16C. Substantially, the user may choice at least one desired channel for watching by user motion or vocal command using aforementioned figure, finger, facial, vocal, eye or the combination.

Another alternative embodiment includes is illustrated in FIG. 17, the identical reference number is the same device or elements mentioned in above embodiments. The present embodiment further includes the ranking module 1700 which is coupled to the control unit to analysis the most favorite contact person, website, or skype user. The module may be incorporated into the cellular device and smart phone or tablet computer a shown in the FIG. 1. In the case, the ranking module 1700 is coupled with the control unit 100 in FIG. 1. The ranking is based on the number of time (or frequency) of communication between the user and the contact person within a period of time or the number of time (or frequency) that the user links to the website within a period of time. Therefore, the ranking module 1700 will have the communication or website linking frequency data calculated by the ranking module 1700 or additional counter of the devices. It will rank my favorite dynamically and display the high ranking contact person, website, or skype user on the interface of desk top or the interface of the address book (or phone number book), account book, my favorite interface dynamically as show in FIGS. 18A and 18B. The ranking module 1700 will re-arrange the queue of the contact person and its related information, such as phone number, e-mail address, user account dynamically based on the frequency of use. If the ranking is altered, the ranking module 1700 will change and re-arrange the queue of the contact person, website, or skype user. In the prior art, the phone number is listed based on the alphabet. The people's name with alphabet A is always listed at the top of the list, however, the people is not necessarily high ranking. The module 1700 can be used in the cellular to dynamically re-arrange the list of the address book, contact book or the phone number book based on the frequency of usage to allow the most high ranking person or website will be listed on the top of the list or first page of the user interface. The device also includes phone filter 1800 coupled to the control unit as shown in FIG. 1 and FIG. 17. The phone filter 1800 includes an interface on the display to allow the user to input the black list of person and corresponding phone number. When the signal of the incoming phone is received, the phone filter 1800 will check whether or not the phone number is listed on the black list. If the incoming phone is already listed in the black list, the phone filter 1800 will hand off the phone automatically without the user action.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

We claim:

1. A portable communication, comprising:
a control unit,
a display coupled to said control unit;
a contact book coupled to the control unit to store a list of contact person's phone number, e-mail address, account information, or the combination;
a ranking module being responsive to a usage frequency of said list of contact person to re-arrange said list of contact person to allow high ranking contact person is listed on a top or a first page of an interface displayed on said display.

2. The portable communication as set forth in claim 1, further includes a phone filter including an interface on a display to allow a user to input a black list of person and corresponding phone number to filter out a phone which is listed in said black list.

3. The portable communication as set forth in claim 3, wherein a signal of said incoming phone is received, said phone filter checks whether or not said incoming phone number is listed on said black list; if said incoming phone is already listed in said black list, said phone filter hands off said phone automatically.

4. The portable communication as set forth in claim 1, further include a multi-tasking module coupled to said control unit for reassigning said control unit between at least one task and another task to achieve parallelism.

5. The portable communication as set forth in claim 1, further comprising a network phone module including a Skype VoIP phone module coupled to said control unit to transmit or receive data through a local area network module.

6. The portable communication as set forth in claim 1, further includes a user motion control module coupled to said control unit.

7. The portable communication as set forth in claim 1, wherein said display includes multiple display windows including at least one main window and at least one sub-window.

8. The portable communication as set forth in claim 7, wherein a selected program is assigned into said main window.

9. A portable communication, comprising:
a control unit,
a display coupled to said control unit;
a contact book coupled to the control unit to store a list of contact person's phone number, e-mail address, account information, or the combination;
a ranking module being responsive to a usage frequency of said list of contact person to re-arrange said list of contact person to allow high ranking contact person is listed on a top or a first page of an interface displayed on said display;
a phone filter including an interface on a display to allow a user to input a black list of person and corresponding phone number to filter out a phone which is listed in said black list.

10. The portable communication as set forth in claim 9, wherein a signal of said incoming phone is received, said phone filter checks whether or not said incoming phone number is listed on said black list; if said incoming phone is already listed in said black list, said phone filter hands off said phone automatically.

11. The portable communication as set forth in claim 9, further include a multi-tasking module coupled to said control unit for reassigning said control unit between at least one task and another task to achieve parallelism.

12. The portable communication as set forth in claim 9, further comprising a network phone module including a Skype VoIP phone module coupled to said control unit to transmit or receive data through a local area network module.

13. The portable communication as set forth in claim 9, further includes a user motion control module coupled to said control unit.

14. The portable communication as set forth in claim 9, wherein said display includes multiple display windows including at least one main window and at least one sub-window.

15. The portable communication as set forth in claim 14, wherein a selected program is assigned into said main window.
